(19) United States
(12) Patent Application Publication
(10) Pub. No.: US 2008/0070745 A1
(43) Pub. Date: Mar. 20, 2008

(54) Gear shift control device for a hybrid electric vehicle

(76) Inventor: Makoto Ogata, Kanagawa (JP)

Correspondence Address: JACOBSON HOLMAN PLLC, 400 SEVENTH STREET N.W., SUITE 600, WASHINGTON, DC, 20004, US

(21) Appl. No.: 11/802,839

(22) Filed: May 25, 2007

(30) Foreign Application Priority Data
Sep. 20, 2006 (JP) 2006-254449

(51) Int. Cl. B60W 10/10

(52) U.S. Cl. 477/15; 903/930

(57) ABSTRACT

A hybrid electric vehicle is capable of transmitting both of a driving force outputted from an engine and a driving force outputted from an electric motor and blocking the transmission of the driving force from the engine to a transmission unit by using a clutch. If the electric motor is in an inoperable state when a gear currently used in the transmission is shifted to a target gear, after disengaging the clutch and bringing the transmission unit into a neutral mode, the vehicle ECU implements temporary engagement control for temporarily engaging and then disengaging the clutch, selects the target gear, and then engages the clutch again.

### BACKGROUND OF THE INVENTION

1. Field of the Invention

The present invention relates to a gear shift control device for a hybrid electric vehicle, and more specifically to a gear shift control device for a hybrid electric vehicle capable of transmitting a driving force of an engine and a driving force of an electric motor to driving wheels.

2. Description of the Related Art

A parallel hybrid electric vehicle has conventionally been developed and in practical use, which is designed to transmit the driving forces outputted from the engine and the electric motor to the driving wheels.

One of such parallel hybrid electric vehicles is a hybrid electric vehicle in which there is provided a clutch capable of blocking the transmission of the driving force from the engine to the automatic transmission unit, and in which the rotary shaft of the electric motor is coupled to between the output shaft of the clutch and the input shaft of the automatic transmission.

When the gears of the automatic transmission unit are shifted in the parallel hybrid electric vehicle, the use of the current gear is canceled while the electric motor is controlled so that a driving torque is not given or received between the electric motor and the automatic transmission unit in a state where the clutch is disengaged. In the next place, the revolution speed synchronization control of the electric motor is carried out so that the input revolution speed of the automatic transmission unit coincides with the target revolution speed on the input side of the transmission unit which is calculated from the output revolution speed of the transmission unit and the gear ratio of a desired gear to be selected. Due to this revolution speed synchronization control, the desired gear is selected at the time point when the actual input revolution speed of the automatic transmission unit substantially coincides with the target input revolution speed, and the clutch is then engaged.

The gear shift control like this reduces a burden imposed upon a synchronizing mechanism at the time of selecting the desired gear. Accordingly, the synchronizing mechanism can be reduced in capacity and improved in durability.

In this parallel hybrid electric vehicle, there is the possibility that the electric motor cannot be operated for some reason, for example, in case that a battery for supplying power to the electric motor is in a over-discharged state or that there is a fault in an inverter circuit for controlling the operation of the electric motor.

To solve this problem, a hybrid electric vehicle is proposed in Unexamined Japanese Patent Publication No. 9-117008 (hereinafter referred to as Document 1), which is designed capable of running by using only an engine in a situation where the electric motor is inoperable.

According to the hybrid electric vehicle of Document 1, when an electric motor breaks down, an operating range of the engine is changed and a gear shift map is changed so as to carry out gear shift control corresponding to the changed operating range. This makes it possible to properly drive the hybrid electric vehicle by using only the engine.

However, if the electric motor becomes inoperable for some reason, the revolution speed synchronization control of the electric motor cannot be carried out when the gears are shifted in the automatic transmission unit. In order to select a desired gear in the automatic transmission unit, revolution in a gear mechanism at the desired gear has to be synchronized by using the synchronizing mechanism installed in the automatic transmission unit. At this point, the input shaft of the automatic transmission unit is connected with the electric motor, so that the input shaft of the automatic transmission unit rotates with a great inertia. It takes time to synchronize the revolution in the gear mechanism at the desired gear, which prolongs the time for the gear shift and also places a heavy burden on the synchronizing mechanism.

This causes problems, such as durability deterioration and breakdown of the synchronizing mechanism. To avoid these problems, a synchronizing mechanism with large capacity has to be installed in the automatic transmission unit. As a result, there generates problems including the size and cost increase of the automatic transmission.

### SUMMARY OF THE INVENTION

An aspect of the present invention is directed to a gear shift control device for a hybrid electric vehicle capable of transmitting both of a driving force outputted from an engine and a driving force outputted from an electric motor to driving wheels, comprising a transmission unit having a plurality of gears and a synchronizing mechanism, the transmission unit being capable of switching between a mode for transmitting a driving force to the driving wheels through a gear selected from the gears and a neutral mode for blocking the transmission of the driving force to the driving wheels without selecting any of the gears; a clutch capable of interrupting the driving force transmitted from the engine to the transmission unit; and control means that, if the electric motor is in an inoperable state when a gear currently used in the transmission unit is shifted to a target gear, carries out, after disengaging the clutch and bringing the transmission unit into the neutral mode, temporary engagement control in which the clutch is temporarily engaged and then disengaged, selects the target gear, and engages the clutch again.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a diagram showing a schematic structure of a hybrid electric vehicle having a control device according to one embodiment of the present invention;

FIG. 2 is a flowchart showing switchover control between gear shift controls;

FIG. 3 is a time chart of normal-time gear shift control; and

FIG. 4 is a time chart of abnormal-time gear shift control.

### DETAILED DESCRIPTION OF THE INVENTION

One embodiment of the present invention will be described below with reference to the attached drawings.

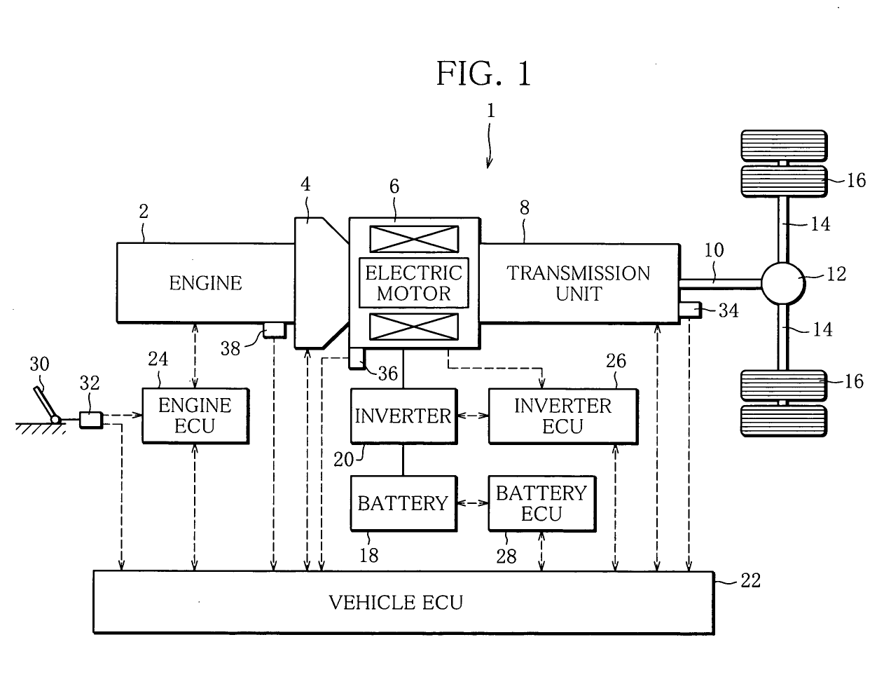

FIG. 1 is a diagram showing the schematic structure of a hybrid electric vehicle 1 to which the present invention is applied.

An input shaft of a clutch 4 is coupled to an output shaft of an engine 2, which is a diesel engine. An output shaft of the clutch 4 is coupled to an input shaft of an automatic transmission unit (hereinafter, referred to as transmission unit) 8 through a rotary shaft of a permanent-magnetic synchronous motor (hereinafter, referred to as electric motor) 6.

In the transmission unit 8, a speed-change gear mechanism, not shown, is installed, which includes a plurality of gears in between the input and output shafts. The transmission unit 8 can be selectively switched between a neutral mode that selects none of the gears and a mode that selects any one of the gears. The transmission unit 8 is so constructed that the gears are shifted while synchronizing revolution in the speed-change gear mechanism by using a synchronizing mechanism, not shown. The output shaft of the transmission unit 8 is connected to right and left driving wheels 16 through a propeller shaft 10, a differential gear unit 12 and driving shafts 14.

When the clutch 4 is engaged, both the output shaft of the engine 2 and the rotary shaft of the electric motor 6 can be mechanically connected with the driving wheels 16 through the transmission unit 8. When the clutch 4 is disengaged, only the rotary shaft of the electric motor 6 can be mechanically connected with the driving wheels 16 through the transmission unit 8.

The electric motor 6 is operated as a motor when DC power stored in a battery 18 is supplied to the electric motor 6 after being converted into AC power by an inverter 20. A driving torque of the electric motor 6 is transmitted to the driving wheels 16 after being shifted to proper speed by the transmission unit 8. At the time of deceleration of the vehicle, the electric motor 6 is operated as a generator. Kinetic energy created by the revolution of the driving wheels 16 is transmitted to the electric motor 6 through the transmission unit 8 to be converted into AC power, thereby producing a deceleration torque based on a regenerative braking force. This AC power is converted into DC power by the inverter 20 and is then charged to the battery 18. In this manner, the kinetic energy created by the revolution of the driving wheels 16 is recovered as electric energy.

Meanwhile, when the clutch 4 is engaged, a driving torque of the engine 2 is transmitted to the transmission unit 8 through the rotary shaft of the electric motor 6. After being shifted to proper speed, the driving torque of the engine 2 is transmitted to the driving wheels 16. Accordingly, if the electric motor 6 is operated as a motor while the driving torque of the engine 2 is transmitted to the driving wheels 16, both the driving torque of the engine 2 and the driving torque of the electric motor 6 are transmitted to the driving wheels 16 through the transmission unit 8. In other words, a part of the driving torque to be transmitted to the driving wheels 16 for driving the vehicle is supplied from the engine 2, and at the same time, the rest of the driving torque is supplied from the electric motor 6.

If a storage rate (hereinafter, referred to as SOC) of the battery 18 lowers, and the battery 18 then needs to be charged, the electric motor 6 is operated as a generator. At the same time, the electric motor 6 is driven by using a part of the driving torque of the engine 2, to thereby carry out power generation. The AC power thus generated is converted into DC power by the inverter 20, and the battery 18 is charged with this DC power.

A vehicle ECU 22 (control means) implements engagement/disengagement control of the clutch 4 and gear shift control of the transmission unit 8 according to an operating state of the vehicle, an operating state of the engine 2, and information from an engine ECU 24, an inverter ECU 26, a battery ECU 28, etc. The vehicle ECU 22 also performs an integrated control for properly controlling the engine 2 and the electric motor 6 in accordance with states of the above-mentioned controls, and various kinds of states, such as start, acceleration and deceleration of the vehicle.

For carrying out these controls, the vehicle ECU 22 is connected to an accelerator opening sensor 32, an output revolution speed sensor (output revolution speed detecting means) 34, a clutch revolution speed sensor (clutch revolution speed detecting means) 36, an engine revolution speed sensor (engine revolution speed detecting means) 38, etc. The accelerator opening sensor 32 detects a depression amount of an accelerator pedal 30. The output revolution speed sensor 34 is installed in the transmission unit 8 and detects output revolution speed of the transmission unit 8. Detection output of the output revolution speed sensor 34 is used to detect traveling speed of the vehicle as well. The clutch revolution speed sensor 36 is mounted on an output shaft of the electric motor 6 and detects output revolution speed of the clutch 4. The engine revolution speed sensor 38 detects revolution speed of the engine 2.

The engine ECU 24 carries out various kinds of controls required for the operation of the engine 2 per se, including start/stop control and idle control of the engine 2, regeneration control of an exhaust emission purifying device (not shown), and the like. Further, the engine ECU 24 controls fuel-injection quantity, fuel injection timing, etc. for the engine 2 so that the engine 2 generates torque required in the engine 2, which has been set by the vehicle ECU 22.

The inverter ECU 26 controls the inverter 20 based on the torque to be generated by the electric motor 6, which has been set by the vehicle ECU 22, and thereby controls the electric motor 6 to be operated as a motor or as a generator. The inverter ECU 26 receives an output signal from a temperature sensor (not shown) for detecting temperature of the electric motor 6 and of the inverter 20, and transmits the temperature of the electric motor 6 to the vehicle ECU 22. The inverter ECU 26 monitors an operating state of the electric motor 6 and of the inverter 20, and transmits the information of the operating state to the vehicle ECU 22.

The battery ECU 28 detects temperature of the battery 18, voltage of the battery 18, current flowing between the inverter 20 and the battery 18, etc. Based upon these detection results, the battery ECU 28 obtains the SOC of the battery 18 and monitors an operating state of the battery 18. The battery ECU 28 transmits the obtained SOC and the operating state of the battery 18 to the vehicle ECU 22 together with the detection results.

In the hybrid electric vehicle 1 thus constructed, controls that are carried out mainly by the vehicle ECU 22 to drive the vehicle will be schematically described below.

If a driver operates a shift lever (not shown) from a neutral position to a drive position while the vehicle is at rest with the engine 2 operating, the vehicle ECU 22 disengages the clutch 4 and brings the transmission unit 8 in the neutral mode into the mode where a start gear is selected according to a gear shift map. When the driver steps on the accelerator pedal 30, the vehicle ECU 22 obtains a driving torque to be transmitted to the driving wheels 16 for starting the vehicle according to the depression amount of the accelerator pedal 30 which has been detected by the accelerator opening sensor 32. The vehicle ECU 22 sets an output torque of the electric motor 6 on the basis of the driving torque and a gear currently used in the transmission unit 8.

The inverter ECU 26 controls the inverter 20 according to the output torque of the electric motor 6 which has been set by the vehicle ECU 22. The DC power of the battery 18 is converted into AC power by the inverter 20 and supplied to the electric motor 6. The electric motor 6 is operated as a motor by being supplied with the AC power, and thereby generates a driving force. The driving force of the electric motor 6 is transmitted to the driving wheels 16 through the transmission unit 8, which start the vehicle.

Once the vehicle accelerates after the start, and the revolution speed of the electric motor 6 increases to the vicinity of the idle speed of the engine 2, it becomes possible to engage the clutch 4 and to transmit a driving force of the engine 2 to the driving wheels 16. The vehicle ECU 22 obtains the driving torque to be transmitted to the driving wheels 16 for further acceleration and subsequent driving of the vehicle. The vehicle ECU 22 properly divides the driving torque between the output torque of the engine 2 and the driving torque of the electric motor 6 according to the gear currently used in the transmission unit 8, the operating state of the vehicle, and the like. The vehicle ECU 22 indicates the output torques of the engine 2 and the electric motor 6 to the ECU 24 and the inverter ECU 26, and controls the transmission unit 8 and the clutch 4 as needed.

Upon receipt of the indication of the output torques that has been set by the vehicle ECU 22, the engine ECU 24 and the inverter ECU 26 control the engine 2 and the electric motor 6, respectively. Therefore, when the clutch 4 is engaged, the output torque of the engine 2 and the output torque of the electric motor 6 are transmitted to the driving wheels 16 through the transmission unit 8, to thereby drive the vehicle. When the clutch 4 is disengaged, the output torque generated by the electric motor 6 is transmitted to the driving wheels 16 through the transmission unit 8, to thereby drive the vehicle.

At this time, the vehicle ECU 22 properly implements the gear shift control of the transmission unit 8 according to the operating state of the vehicle, including the depression amount of the accelerator pedal 30 which has been detected by the accelerator opening sensor 32, the traveling speed obtained from the output revolution speed of the transmission unit 8 which has been detected by the output revolution speed sensor 34. At this point, the vehicle ECU 22 commands the engine ECU 24 and the inverter ECU 26 to properly control the torque of the engine 2 and the torque of the electric motor 6 in response to the gear shift. Moreover, the vehicle ECU 22 controls the engagement and disengagement of the clutch 4 as needed.

Based upon the information transmitted from the inverter ECU 26 and the battery ECU 28, the vehicle ECU 22 monitors whether the hybrid electric vehicle 1 is in a state capable of operating the electric motor 6. Conditions in which the electric motor 6 is inoperable include reduction of the SOC of the battery 18, a defect in a cell, a problem in an inverter circuit (not shown) in the inverter 20, abnormal temperature rise in the electric motor 6, etc. If the electric motor 6 is inoperable due to such conditions, the vehicle ECU 22 interrupts an electrical connection between the battery 18 and the inverter 20, and controls the engine 2 and the electric motor 6 so as to drive the vehicle by using only the driving force of the engine 2.

At this time, the vehicle ECU 22 switches between the gear shift controls for selecting a gear, depending upon whether the electric motor 6 is operable.

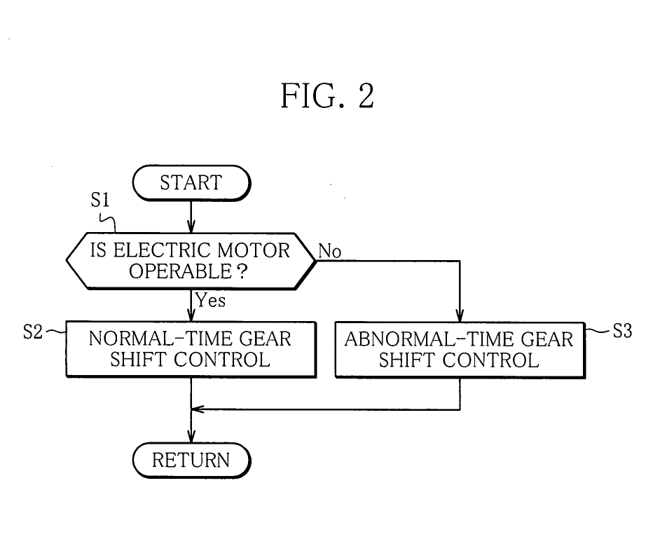

The switchover control between the gear shift controls is carried out by the vehicle ECU 22 in a predetermined control cycle according to a flowchart shown in FIG. 2.

When the switchover control of the gear shift controls is started, the vehicle ECU 22 makes a determination in Step S1 as to whether the electric motor 6 is operable on the basis of the information from the inverter ECU 26 and the battery ECU 28.

If the vehicle ECU 22 determines in Step S1 that the electric motor 6 is operable, the vehicle ECU 22 selects normal-time gear shift control in Step S2 and thereafter completes the control cycle. If the vehicle ECU 22 determines in Step S1 that the electric motor 6 is inoperable, the vehicle ECU 22 selects abnormal-time gear shift control in Step S3 and thereafter completes the control cycle.

By repeating the determination in Step S1 in each control cycle as described above, the vehicle ECU 22 selects the normal-time gear shift control or the abnormal-time gear shift control depending upon whether the electric motor 6 is operable.

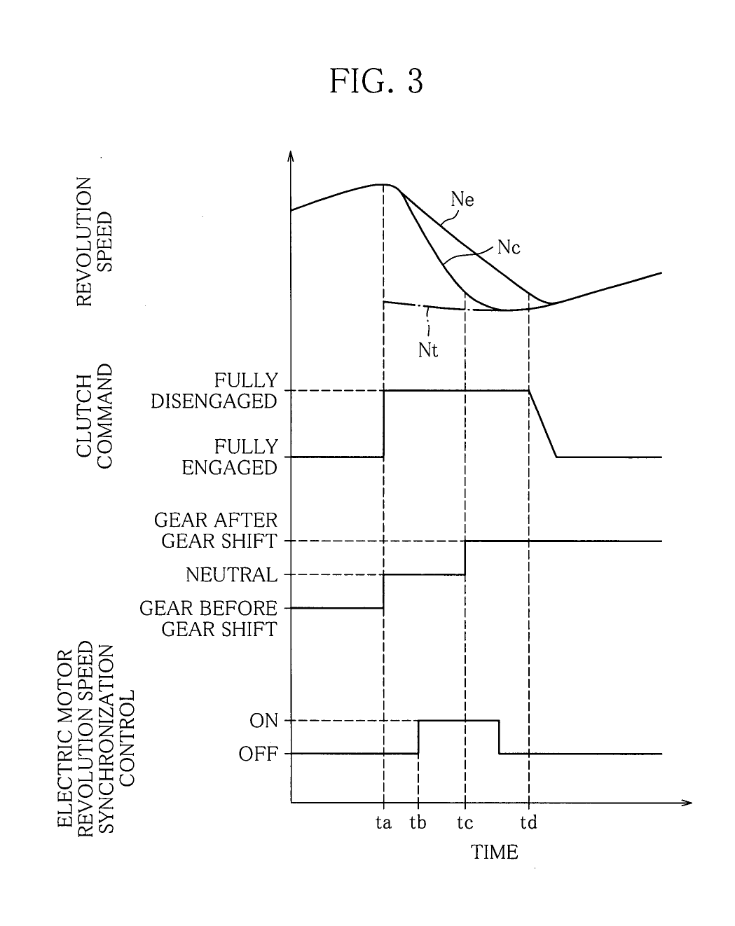

The normal-time gear shift control that is selected when it is determined that the electric motor 6 is operable will be described below with reference to FIG. 3.

FIG. 3 is a time chart showing, as an example, a condition of the hybrid electric vehicle 1 when the gear shift (upshift) is carried out by the normal-time gear shift control during acceleration of the vehicle. FIG. 3 shows engine revolution speed Ne, output revolution speed Nc of the clutch 4, a command signal from the vehicle ECU 22 to the clutch 4, a command signal from the vehicle ECU 22 to the transmission unit 8, and ON and OFF states of the revolution speed synchronization control of the electric motor 6, which is commanded by the vehicle ECU 22 to the inverter ECU 26, in the order from the top of FIG. 3.

If the vehicle ECU 22 determines gear shift according to the gear shift map while the vehicle is driven in a certain gear (gear before gear shift), at the point of time ta, the vehicle ECU 22 controls the clutch 4 so that the clutch 4 is fully disengaged. At the same time, the vehicle ECU 22 commands the engine ECU 24 to stop fuel supply to the engine 2 to decelerate the engine 2. Due to the control of the vehicle ECU 22, the clutch 4 is transferred from a fully engaged state to the fully disengaged state. Since the engine ECU 24 stops the fuel supply to the engine 2 upon receipt of the command from the vehicle ECU 22, the engine revolution speed Ne are decreased.

At the time ta, the vehicle ECU 22 commands the inverter ECU 26 so that the torque is not given and received between the electric motor 6 and the transmission unit 8. The vehicle ECU 22 simultaneously outputs a control signal to the transmission unit 8 to cancel the use of the gear currently used in the transmission unit 8 so that the transmission unit 8 enters the neutral mode.

The inverter ECU 26 controls the electric motor 6 according to the command from the vehicle ECU 22. As a result, when the torque is hardly given and received between the electric motor 6 and the transmission unit 8 at the point of time tb, the use of the gear currently used in the transmission unit 8 is cancelled, and the transmission unit 8 enters the neutral mode.

The vehicle ECU 22 calculates input revolution speed of the transmission unit 8, which is expected to be achieved after the gear is shifted to a target gear (gear after gear shift), as a target revolution speed Nt on the basis of the output revolution speed of the transmission unit 8 which has been detected by the output revolution speed sensor 34 and a gear ratio of the target gear. After the transmission unit 8 enters the neutral mode, the vehicle ECU 22 commands the inverter ECU 26 to implement the revolution speed synchronization control that equalizes the input revolution speed of the transmission unit 8, or output revolution speed Nc of the clutch 4 which has been detected by the clutch revolution speed sensor 36, with the target revolution speed Nt by controlling the electric motor 6.

According to the command from the vehicle ECU 22, the inverter ECU 26 implements the revolution speed synchronization control and controls the electric motor 6, to thereby decelerate the electric motor 6. Consequently, the output revolution speed Nc of the clutch 4 is reduced toward the target revolution speed Nt shown by a chain line in FIG. 3.

At the point of time tc, if deviation between the output revolution speed Nc of the clutch 4 which has been detected by the clutch revolution speed sensor 36 and the target revolution speed Nt becomes, for example, several tens rpm or less, and the output revolution speed Nc approximates to the target revolution speed Nt, the vehicle ECU 22 outputs a control signal to the transmission unit 8 so as to select the target gear.

Due to the revolution speed synchronization control of the electric motor 6 which is carried out by the inverter ECU 26, the target gear is selected in the transmission unit 8 when the output revolution speed Nc of the clutch 4, that is, the input revolution speed of the transmission unit 8, becomes virtually equal to the target revolution speed Nt.

Since the target gear is selected in this manner, it becomes possible to smoothly shift the gears, preventing a gear noise and a shock. As a burden placed upon the synchronizing mechanism of the transmission unit 8 is reduced, the synchronizing mechanism is improved in durability.

Even while the target gear is selected, the engine revolution speed Ne continue to decrease. If deviation between the engine revolution speed Ne and the output revolution speed Nc of the clutch 4 becomes, for example, several tens rpm or less at the point of time td, the vehicle ECU 22 gradually engages the clutch 4 and eventually brings the clutch 4 into the fully engaged state.

Since the engine revolution speed Ne are the input revolution speed of the clutch 4, the clutch 4 can be engaged without causing a shock by engaging the clutch 4 in the state where the deviation between the engine revolution speed Ne and the output revolution speed Nc of the clutch 4 is small as described above. As a result, the clutch 4 can be improved in durability.

Simultaneously with when the clutch 4 enters the fully engaged state, the vehicle ECU 22 indicates the respective torques to the engine ECU 24 and the inverter ECU 26 so that the torque to be transmitted from the engine 2 and the electric motor 6 to the transmission unit 8 becomes the target torque required for driving the vehicle. The vehicle ECU 22 then finishes the normal-time gear shift control. According to the indication from the vehicle ECU 22, the engine ECU 24 and the inverter ECU 26 control the engine 2 and the electric motor 6, respectively. The torques transmitted from the engine 2 and the electric motor 6 to the driving wheels 16 through the transmission unit 8 make the vehicle continue to run.

In this way, when the electric motor 6 is operable, it is possible to prevent a gear noise and a shock by carrying out the revolution speed synchronization control of the electric motor 6 while selecting the target gear. This makes it possible to accomplish smooth gear shift and to improve the durability of the synchronizing mechanism by reducing a burden placed upon the synchronizing mechanism of the transmission unit 8.

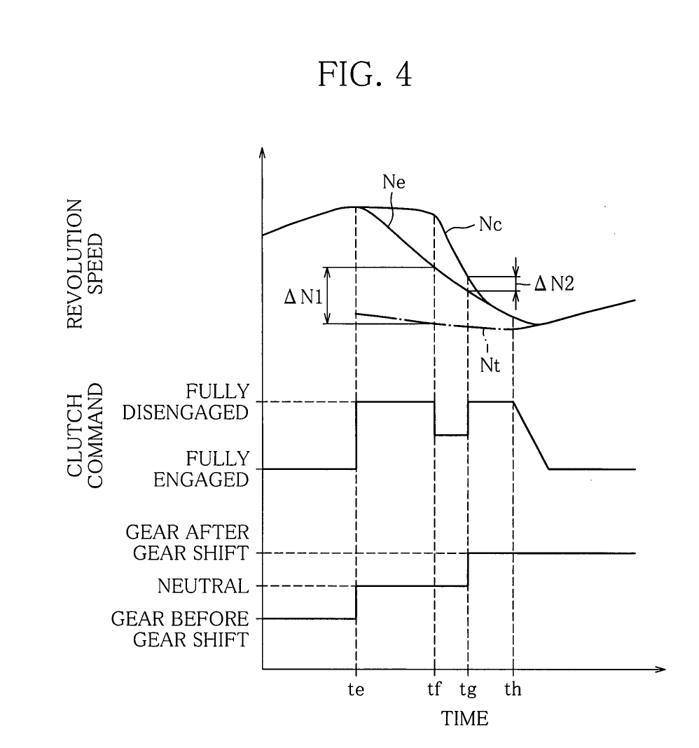

Meanwhile, the abnormal-time gear shift control that is selected when it is determined that the electric motor 6 is inoperable will be described below with reference to FIG. 4.

FIG. 4 is a time chart showing in the same manner as in FIG. 3, as an example, a state of the hybrid electric vehicle 1 at the time when the gearshift (upshift) is carried out by the abnormal-time gear shift control during acceleration of the vehicle. Since the revolution speed synchronization control of the electric motor 6 cannot be performed as the electric motor 6 is in the inoperable state, the revolution speed synchronization control is omitted from FIG. 6.

While the vehicle is driven in a certain gear (gear before gear shift), if the vehicle ECU 22 determines to shift the gears according to the gear shift map, the vehicle ECU 22 controls the clutch 4 so that the clutch 4 enters the fully disengaged state at the point of time te. The vehicle ECU 22 simultaneously commands the engine ECU 24 to stop the fuel supply to the engine 2 to decelerate the engine 2. Because of the control of the vehicle ECU 22, the clutch 4 is transferred from the fully engaged state to the fully disengaged state, and at the same time, the engine ECU 24 stops the fuel supply to the engine 2 according to the command from the vehicle ECU 22. As a result, the engine revolution speed Ne are decreased.

At this time, the output revolution speed Nc of the clutch 4, namely the input revolution speed of the transmission unit 8, is slowly reduced since the revolution speed synchronization control of the electric motor 6 is not performed, and the electric motor 6 has a great inertia.

At the point of the time te, the vehicle ECU 22 outputs a control signal to the transmission unit 8 to cancel the use of the gear currently used in the transmission unit 8 so that the transmission unit 8 enters the neutral mode. Accordingly, the use of the current gear is cancelled, and the transmission unit 8 enters the neutral mode.

The vehicle ECU 22 calculates revolution speed on the input side of the transmission unit 8, which is expected to be achieved after the gear is shifted to the target gear (gear after gear shift), as target revolution speed Nt on the basis of the output revolution speed of the transmission unit 8 which has been detected by the output rotational sensor 34 and the gear ratio of the target gear, as with the normal-time gear shift control.

Once the engine revolution speed Ne are decreased due to the stop of the fuel supply to the engine 2, and at the point of time tf, deviation ΔN1 between the engine revolution speed Ne and the target revolution speed Nt shown by a chain line in FIG. 4 becomes equal to or less than a first predetermined value (for example, several hundreds rpm) that is separately preset with respect to each gear of the transmission unit 8, the vehicle ECU 22 starts the temporary engagement control of the clutch 4 and brings the clutch 4 into a partially engaged state.

Since the clutch 4 is brought into the partially engaged state, kinetic energy of the electric motor 6 on the output side of the clutch 4 is absorbed to the engine 2 side. Therefore, the output revolution speed Nc of the clutch 4 is drastically reduced. If, at the point of time tg, deviation ΔN2 between the output revolution speed Nc of the clutch 4 and the engine revolution speed Ne becomes equal to or less than a second predetermined value (for example, several tens rpm) that is separately preset with respect to each gear of the transmission unit 8, the vehicle ECU 22 brings the clutch 4 into the fully disengaged state again., to thereby finish the temporary engagement control of the clutch 4. At the same time, the vehicle ECU 22 outputs a control signal to the transmission unit 8 to select the target gear.

Upon receipt of the control signal from the vehicle ECU 22, the synchronizing mechanism is operated to carry out the revolution synchronization in the gear mechanism of the target gear in the transmission unit 8, and the target gear is selected.

By selecting the target gear after the temporary engagement control of the clutch 4 is performed to reduce the output revolution speed Nc of the clutch 4, the output revolution speed Nc of the clutch 4, namely the input revolution speed of the transmission unit 8, can be rapidly reduced even if the revolution speed synchronization control by the electric motor 6 cannot be carried out.

It is then possible to immediately approximate the input revolution speed of the transmission unit 8 to the input revolution speed of the transmission unit 8 which is expected to be achieved after the target gear is selected. This makes it possible to shorten the time for the target gear selection carried out by the synchronizing mechanism of the transmission unit 8. It is also possible to reduce the burden placed upon the synchronizing mechanism. Accordingly, it is not necessary to increase capacity of the synchronizing mechanism on the assumption that the electric motor 6 becomes inoperable. Therefore, the transmission unit 8 can be downsized and reduced in cost.

Since the temporary engagement control is designed to start when the deviation ΔN1 between the engine revolution speed Ne and the target revolution speed Nt becomes equal to or less than the first predetermined value, it is possible to immediately reduce the output revolution speed of the clutch 4 by implementing the temporary engagement control after the engine revolution speed Ne are sufficiently decreased.

The temporary engagement control of the clutch 4 is not implemented until the deviation ΔN1 between the engine revolution speed Ne and the target revolution speed Nt becomes the first predetermined value or less. For this reason, the clutch 4 does not enter the partially engaged state for a long period. It is therefore possible to prevent abrasion of the clutch 4 and to improve the durability of the clutch 4.

Since the target gear is selected after the deviation ΔN1 between the engine revolution speed Ne and the target revolution speed Nt becomes equal to or less that the first predetermined value, and the temporary engagement control of the clutch 4 is carried out, it is possible to reduce the deviation between the actual input revolution speed of the transmission unit 8 at the time of selecting the target gear and the target revolution speed to the first predetermined value or less. As a result, the capacity of the synchronizing mechanism of the transmission unit 8 is sufficient as long as it at least corresponds to rotational deviation of the first predetermined value. If the first predetermined value is set according to the capacity of the synchronizing mechanism to be employed, it becomes possible to prevent the synchronizing mechanism from being imposed with an excessive burden and to improve the durability of the synchronizing mechanism.

If the synchronizing mechanism with the capacity corresponding to the first predetermined value is employed after the first predetermined value is set according to characteristics such as required gear shift time, it is possible to employ a proper synchronizing mechanism instead of using a synchronizing mechanism with excessive capacity or one with insufficient capacity.

When the clutch 4 is engaged by the temporary engagement control, the clutch 4 is brought into the partially engaged state. It is therefore possible to shorten the time for the engagement and disengagement of the clutch 4 during the temporary engagement control. This consequently reduces the time required for the gear shift.

After the clutch 4 is temporarily engaged by the temporary engagement control, the clutch 4 continues to be engaged until the deviation between the engine revolution speed Ne and the output revolution speed Nc of the clutch becomes equal to or less than the second predetermined value. Such engagement of the clutch 4 sufficiently reduces the output revolution speed of the clutch 4, namely the input revolution speed of the transmission unit 8, to the vicinity of the engine revolution speed Ne. As a result, after the temporary engagement control of the clutch 4, the target gear can be selected in the state where the deviation between the actual input revolution speed of the transmission unit 8 and the input revolution speed of the transmission unit 8 which is expected to be achieved after the gear shift becomes small. It is then possible to smoothly select the target gear, preventing a gear noise and a shock. It is also possible to reduce the burden placed upon the synchronizing mechanism and to improve the durability of the synchronizing mechanism.

After the target gear is thus selected, when the deviation between the engine revolution speed Ne and the output revolution speed Nc of the clutch 4 becomes, for example, several tens rpm or less at the point of time th, the vehicle ECU 22 gradually engages clutch 4 to bring the clutch 4 into the fully engaged state.

By engaging the clutch 4 in the state where the deviation between the engine revolution speed Ne, namely the input revolution speed of the clutch 4, and the output revolution speed Nc of the clutch 4 is small as described above, the clutch 4 can be engaged without causing a shock. Consequently, the clutch 4 can be improved in durability.

Simultaneously with when the clutch 4 enters the fully engaged state, the vehicle ECU 22 commands the engine ECU 24 so that the torque to be transmitted from the engine 2 to the transmission unit 8 becomes the target torque required for driving the vehicle, and finishes the normal-time gear shift control. The engine ECU 24 controls the engine 2 according to the command from the vehicle ECU 22. The torque that is transmitted from the engine 2 to the driving wheels 16 through the transmission unit 8 makes the vehicle continue to run.

Although the gear shift control device for a hybrid electric vehicle according to one embodiment of the present invention will be finished here, the invention is not limited to the above-described embodiment.

For instance, if the electric motor 6 is inoperable in the embodiment, the clutch 4 is disengaged and the transmission unit 8 is brought into the neutral mode. Thereafter, when the deviation ΔN1 between the engine revolution speed Ne and the target revolution speed Nt becomes equal to or less than the first predetermined value, the vehicle ECU 22 implements the temporary engagement control that temporarily engages the clutch 4. However, timing to implement the temporary engagement control is not limited to this.

Stated differently, for example, when elapsed time from the disengagement of the clutch 4 for gear shift reaches predetermined time, the vehicle ECU 22 may start the temporary engagement control. Alternately, after the clutch 4 is disengaged and the transmission unit 8 is brought into the neutral mode, when the engine revolution speed Ne become equal to or less than predetermined revolution speed which is set on the basis of the traveling speed and the gear ratio of the target gear, the vehicle ECU 22 may start the temporary engagement control.

According to the embodiment, the clutch 4 is brought into the partially engaged state during the temporary engagement control of the clutch 4, the clutch 4 may be fully engaged. In this case, although the time required for the engagement and disengagement of the clutch 4 is increased, it is possible to reduce the output revolution speed Nc of the clutch 4, namely the input revolution speed of the transmission unit 8, to the engine revolution speed Ne more promptly by fully engaging the clutch 4.

According to the embodiment, after the temporary engagement control is started, when the deviation ΔN2 between the output revolution speed Nc of the clutch 4 and the engine revolution speed Ne becomes equal to or less than the second predetermined value, the vehicle ECU 22 disengages the clutch 4 and finishes the temporary engagement control. However, timing to finish the temporary engagement control is not limited to this. For instance, the vehicle ECU 22 may finish the temporary engagement control when elapsed time from the start of the temporary engagement control reaches predetermined time.

According to the embodiment, the output revolution speed of the transmission unit 8 is detected by the output revolution speed sensor 34 installed in the transmission unit 8. However, the location of the output revolution speed sensor 34 is not limited to this. The output revolution speed sensor 34 may detect the output revolution speed of the transmission unit 8 in between the transmission unit 8 and the driving wheels 16.

According to the embodiment, the output revolution speed of the clutch 4 is detected by the clutch revolution speed sensor 36 installed in the electric motor 6. This is to utilize the revolution speed sensor that is primarily provided to the electric motor 6 for the purpose of controlling the electric motor 6. Therefore, the clutch revolution speed sensor 36 may be disposed on the output side of the clutch 4 or on the input side of the transmission unit 8 independently of the revolution speed sensor primarily provided in the electric motor 6. In this case, however, an extra revolution speed sensor is required.

According to the embodiment, at the time of gear shift, the engine ECU 24 decelerates the engine 2 by stopping the fuel supply to the engine 2 in accordance with the command from the vehicle ECU 22. However, if the engine 2 is provided with a decelerator for the engine 2, such as an exhaust braking system, the engine 2 may be decelerated by using such a decelerator at the same time. If the decelerator is used at the same time, the engine 2 can be further rapidly decelerated, so that the time required for the gear shift can be further reduced.

Although the engine 2 is a diesel engine in the embodiment, the engine is not limited to this type. Likewise, the electric motor 6 is a permanent-magnetic synchronous motor in the embodiment, but it is not limited to this type, either.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A gear shift control device for a hybrid electric vehicle capable of transmitting both of a driving force outputted from an engine and a driving force outputted from an electric motor to driving wheels, comprising:
a transmission unit having a plurality of gears and a synchronizing mechanism, the transmission unit being capable of switching between a mode for transmitting a driving force to the driving wheels through a gear selected from the gears and a neutral mode for blocking the transmission of the driving force to the driving wheels without selecting any of the gears;
a clutch capable of interrupting the driving force transmitted from the engine to the transmission unit; and
control means that, if the electric motor is in an inoperatable state when a gear currently used in the transmission unit is shifted to a target gear, carries out, after disengaging the clutch and bringing the transmission unit into the neutral mode, temporary engagement control in which the clutch is temporarily engaged and then disengaged, selects the target gear, and engages the clutch again.

2. The gear shift control device for a hybrid electric vehicle according to claim 1, further comprising:
engine revolution speed detecting means for detecting revolution speed of the engine; and
output revolution speed detecting means for detecting output revolution speed of the transmission unit, wherein
the control means calculates revolution speed on an input side of the transmission unit, which is expected to be achieved after gear shift, as target revolution speed on the basis of output revolution speed of the transmission unit detected by the output revolution speed detecting means and a gear ratio of the target gear, and temporarily engages the clutch by implementing the temporary engagement control when deviation between the engine revolution speed detected by the engine revolution speed detecting means and the target revolution speed becomes equal to or less than a first predetermined value.

3. The gear shift control device for a hybrid electric vehicle according to claim 1, wherein
the control means brings the clutch into a partially engaged state when temporarily engaging the clutch by implementing the temporary engagement control.

4. The gear shift control device for a hybrid electric vehicle according to claim 1, further comprising:
clutch revolution speed detecting means for detecting output revolution speed of the clutch, wherein
the control means temporarily engages the clutch by implementing the temporary engagement control, and thereafter disengages the clutch when deviation between the engine revolution speed detected by the engine revolution speed detecting means and the output revolution speed of the clutch detected by the clutch revolution speed detecting means becomes equal to or less than a second predetermined value.
